(19) United States
(12) Patent Application Publication
(10) Pub. No.: US 2017/0294252 A1
(43) Pub. Date: Oct. 12, 2017

(54) Systems and Methods for Producing Tapered Resistive Cards and Capacitive Sheets

(71) Applicant: Lockheed Martin Corporation, Bethesda, MD (US)

(72) Inventors: Jatooporn Pholtavee, Valencia, CA (US); Jaime Ballester, Palmdale, CA (US); Thomas Richard Steiner, Palmdale, CA (US); William Kui-Kun Ng, Valencia, CA (US); Arthur James Bietsch, III, Palmdale, CA (US)

(21) Appl. No.: 15/095,700

(22) Filed: Apr. 11, 2016

(51) Int. Cl. H01C 17/00; H01C 7/20

(52) U.S. Cl. CPC H01C 17/00; H01C 7/20

(57) ABSTRACT

In certain embodiments, a method comprises ablating, by a laser set to a first power level, a first area of a polyimide base substrate and forming, by ablating the first area of the polyimide base substrate, a first carbonaceous material film comprising a first specific resistive value. The method further comprises ablating, by the laser set to a second power level, a second area of the polyimide base substrate and forming, by ablating the second area of the polyimide base substrate, a second carbonaceous material film comprising a second specific resistive value. A tapered resistive material is produced by forming the first carbonaceous material film comprising the first specific resistive value and the second carbonaceous material film comprising the second specific resistive value.

### TECHNICAL FIELD

The present disclosure relates in general to resistive materials, and more specifically to systems and methods for producing tapered resistive cards and capacitive sheets.

### BACKGROUND

Current techniques to produce resistive cards and capacitive sheets require a manually intensive silk-screen process that can only produce materials with single resistive values. The output quality of this manual silk-screen process is dependent on the skill of the operator. Further, the output rate is low and is limited to two-dimensional flat sheets.

### SUMMARY OF THE DISCLOSURE

In accordance with the present disclosure, disadvantages and problems associated with producing tapered resistive cards and capacitive sheets may be reduced or eliminated.

In one embodiment, a method includes determining an ablation path using a computer numerical control (“CNC”) program. The method also includes ablating, by a laser set to a first power level, a first area of a polyimide base substrate based on the determined ablation path; digitally controlling, by a controller and while ablating the first area of the polyimide substrate, the first laser power level and a first duration of the first area ablation; and forming, by ablating the first area of the polyimide base substrate, a first carbonaceous material film comprising a first resistive value.

The method of this embodiment further includes ablating, by the laser set to a second power level, a second area of the polyimide base substrate based on the determined ablation path; digitally controlling, by the controller and while ablating the second area of the polyimide substrate, the second laser power level and a second duration of the second area ablation; and forming, by ablating the second area of the polyimide base substrate, a second carbonaceous material film comprising a second resistive value. The method further includes producing, using the first carbonaceous material film comprising the first resistive value and the second carbonaceous material film comprising the second resistive value, a tapered resistive material.

In some embodiments, a tapered resistive material comprises a first carbonaceous material film including a first resistive value, the first resistive value formed by ablating a first area of a polyimide base substrate with a laser while the laser is set to a first power level. The tapered resistive material further comprises a second carbonaceous material film including a second resistive value formed by ablating a second area of the polyimide base substrate with the laser while the laser is set to a second power level.

Technical advantages of the disclosure include ablating an area of a polyimide base substrate using a laser, which allows for complex designs. Further, by digitally controlling the laser power level, the substrate can be ablated to form different resistive values. An additional technical advantage is that multiple lasers may be used to ablate specific areas of the substrate to address output speed. Further, laser ablation affords a more open design space to tailor specific areas of a substrate to smooth and continuous varying resistive values. Another technical advantage is that the laser ablation method can be applied to two-dimensional flat surfaces as well as three-dimensional surfaces with compound curvature. Other technical advantages will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates a system for producing a tapered resistive material, according to certain embodiments;

FIG. 2 illustrates an ablation path that may be used by the system of FIG. 1, according to certain embodiments;

FIG. 3 illustrates a method for producing a tapered resistive material, according to certain embodiments; and

FIG. 4 illustrates a computer system that may be used by the system of FIG. 1, according to certain embodiments.

### DETAILED DESCRIPTION OF THE DISCLOSURE

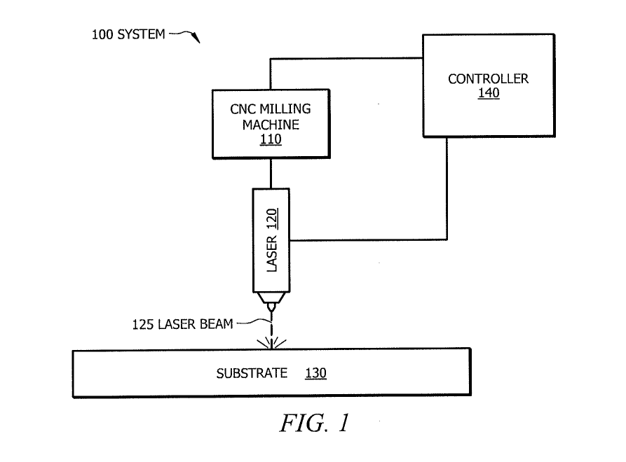

To facilitate a better understanding of the present disclosure, the following examples of certain embodiments are given. The following examples are not to be read to limit or define the scope of the disclosure. Embodiments of the present disclosure and its advantages are best understood by referring to FIGS. 1 through 4, where like numbers are used to indicate like and corresponding parts.

Current techniques to produce tapered resistive materials require a manually intensive silk-screen process that can only produce materials with single resistive values. The output quality of this manual silk-screen process is dependent on the skill of the operator, and the output rate is typically low and is limited to two-dimensional flat sheets. Further, because this silk-screen process is only capable of manufacturing sheets with a single resistive value, producing a sheet with multiple resistive values requires assembling multiple different sheets. For example, different manufactured sheets with different resistive values may be bonded together to create a taper.

To reduce or eliminate these and other problems, some embodiments of the present disclosure include ablating an area of a polyimide base substrate using a laser, which allows for complex shapes. Further, by changing the laser power level, the substrate can be ablated to form different resistive values on a single two-dimensional or three-dimensional surface via on-assembly in-situ manufacturing. An additional technical advantage is that multiple lasers may be used to ablate specific areas of the substrate to increase output speed. Further, laser ablation affords a more open design space to tailor specific areas to smooth and continuous varying resistive values. Another technical advantage is that the laser ablation method can be applied to two-dimensional flat surfaces as well as three-dimensional surfaces with compound curvature.

Other technical advantages will be readily apparent to one skilled in the art from the following figures, descriptions, and claims. Moreover, while specific advantages have been enumerated above, various embodiments may include all, some, or none of the enumerated advantages. FIGS. 1-4 provide additional details relating to systems and methods for producing tapered resistive cards and capacitive sheets.

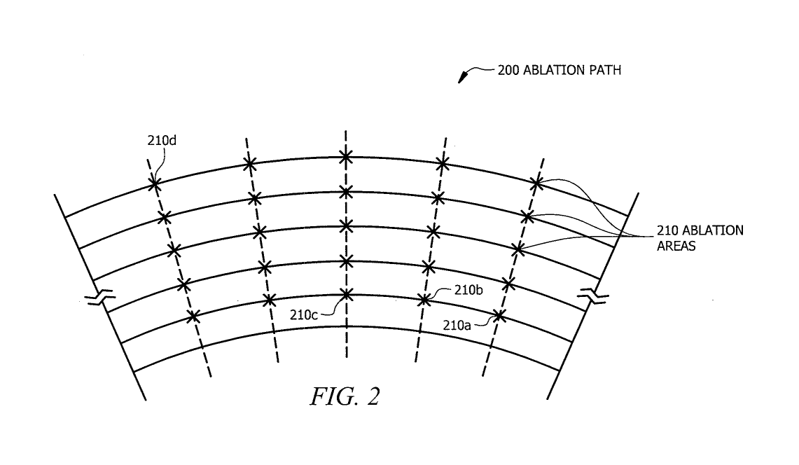

FIG. 1 illustrates a system for producing a tapered resistive material, according to certain embodiments. As shown in the embodiment of FIG. 1, system 100 includes a computer numerical control (“CNC”) milling machine 110, a laser 120, a substrate 130, and a controller 140. CNC milling machine 110 may be programmed to determine an ablation path. An example of an ablation path is described in more detail in FIG. 2.

In the illustrated embodiment of FIG. 1, laser 120 is physically attached to CNC milling machine 110. In certain embodiments, laser 120 may be physically separated from CNC milling machine 110. For example, laser 120 may be physically separated from CNC milling machine 110 while being electrically coupled to CNC milling machine 110. In general, laser 120 may be positioned in any appropriate manner in order to direct a laser beam 125 onto substrate 130. Substrate 130 may be any substrate operable to produce a carbonaceous material film. For example, substrate 130 may be a polyimide base substrate operable to produce a graphene film. In certain embodiments, substrate 130 includes one or more two-dimensional surfaces. In some examples, substrate 130 may include one or more three-dimensional surfaces.

In the embodiment of FIG. 1, laser 120 is operable to ablate a first area of substrate 130 while set to a first power level. Laser 120 may be further operable to ablate a second area of substrate 130 while set to a second power level. In certain embodiments, laser 120 is operable to ablate multiple areas of substrate 130 at different power levels. For example, laser 120 may be operable to ablate one hundred distinct areas of substrate 130 while set at one hundred different power levels, respectively. As another example, laser 120 may be operable to ablate one hundred distinct areas of substrate 130 while set at fifty different power levels.

In certain embodiments, the one or more ablated areas of substrate 130 form a carbonaceous material film (e.g., a graphene film), wherein the carbonaceous material film of each ablated area has a specific resistive value. For example, the ablation of a first area of a polyimide base substrate (e.g., substrate 130) by laser 120 may form a carbonaceous material film with a resistive value of 100 ohms-per-square. As another example, laser 120 may form a carbonaceous material film over several different areas of substrate 130, wherein a first area comprises a resistive value of 200 ohms-per-square, a second area comprises a resistive value of 300 ohms-per-square, a third area comprises a resistive value of 300 ohms-per-square, a fourth area comprises a resistive value of 250 ohms-per-square, and so on.

Laser 120 may produce laser beam 125 that has any wavelength operable to form a carbonaceous material film with a desired resistive value. In some embodiments, the wavelength of laser beam 125 is in a near to mid infrared regime. In certain embodiments, the wavelength of laser beam 125 is greater than or equal to nine microns but less than or equal to eleven microns. For example, laser 120 may operate at a wavelength of 10.6 microns. As another example, laser 120 may operate at a wavelength of 9.4 microns. Laser 120 may be any type of laser operable to form a carbonaceous material film with a desired resistive value. In the illustrated embodiment of FIG. 1, laser 120 is a near to mid infrared laser. In some embodiments, laser 120 is a carbon dioxide laser. In certain embodiments, laser 120 is a neodymium-doped yttrium aluminum garnet (Nd:YAG) laser.

In some embodiments, laser 120 includes two or more lasers. For example, a first laser 120 and a second laser 120 may be attached to CNC milling machine 110. The first laser 120 may be operable to ablate a first area of a polyimide base substrate 130 and the second laser 120 may be operable to ablate a second area of the polyimide base substrate 130. Multiple lasers may be used to address output speed. For instance, first and second lasers 120 may operate simultaneously to ablate two distinct areas of substrate 120 at the same time.

In some embodiments, a tapered resistive material may be produced by forming carbonaceous material film on substrate 130. For example, tapered resistive material (e.g., a tapered resistive card or a capacitive sheet) may be produced by forming a first carbonaceous material film on substrate 130 while laser 120 is set to a first power level, by forming a second carbonaceous material film on substrate 130 while laser 120 is set to a second power level, and so on. The resistive values may be any values operable to form a tapered resistive material. For example, a first resistive value of the tapered resistive material may be 100 ohms-per-square whereas a second resistive value of the same tapered resistive material may be 4000 ohms-per-square.

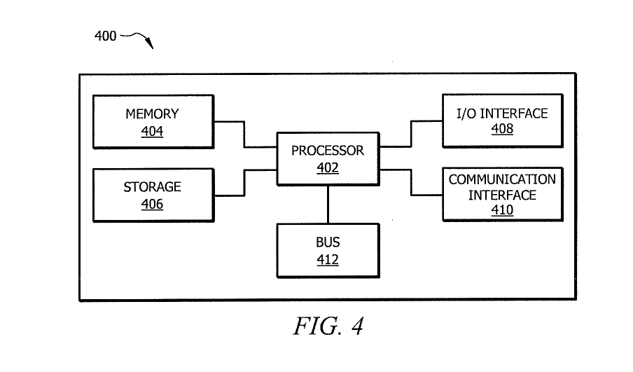

Controller 140, as shown in the illustrated embodiment of FIG. 1, may control one or more components of system 100. In certain embodiments, controller 140 is operable to program CNC milling machine 110 to one or more ablation paths. In some embodiments, controller 140 is operable to set the power level of laser 120. For example, controller 140 may be operable to set laser 120 to a first power level for a certain duration of time, set laser 120 to a second power level for a certain duration of time, and so on. Controller 140 may comprise one or more processors, one or more memories, and one or more interfaces, and may include or be formed by a computer system such as computer system 400, which is discussed in more detail with respect to FIG. 4 below.

FIG. 2 illustrates an ablation path 200 that may be used by the system of FIG. 1, according to certain embodiments. Ablation path 200 may be determined by a CNC program. For example, a CNC program of CNC milling machine 110 may determine ablation path 200 with multiple distinct ablation areas 210 (e.g., twenty distinct ablation areas 210), as shown in FIG. 2. In some embodiments, ablation path 200 may be determined by converting a raster image comprising a path to a vector file and importing the vector file into the CNC program.

In the illustrated embodiment of FIG. 2, each ablation area 210 has a distinct resistive value. As an example, ablation area 210a may have a resistive value of 600 ohms-per-square, ablation area 210b may have a resistive value of 600 ohms-per-square, ablation area 210c may have a resistive value of 550 ohms-per-square, and so on. In certain embodiments, each resistive value is associated with a power level. For example, a power wattage of laser 120 may be adjusted to produce carbonaceous material of a specific resistive value at ablation area 210a. In some embodiments, each resistive value is associated with a duration of time that laser 120 is operating in any given area (e.g., area 210a or area 210b).

In certain embodiments, ablation areas 210 of ablation path 200 may be represented by coordinates. For example, each ablation area 210 of FIG. 2 may be represented by an X-coordinate and a Y-coordinate. As another example, each ablation area 210 may be represented by an X-coordinate, a Y-coordinate, and a Z-coordinate. A two-coordinate system may be utilized for two-dimensional surfaces and a three-coordinate system may be utilized for a three-dimensional surfaces. The resulting pattern of coordinates may be used to program the order and location of the laser ablation.

Ablation path 200 may comprise any pattern and any order of ablation. In the illustrated embodiment of FIG. 2, the pattern of ablation path 200 is a semicircle, and the order of ablation moves in a serpentine pattern from ablation area 210a to ablation area 210d. As another example, ablation path 200 may comprise a donut-shaped pattern and the order of ablation may move in a circular pattern. In certain embodiments, ablation path may comprise a complex pattern.

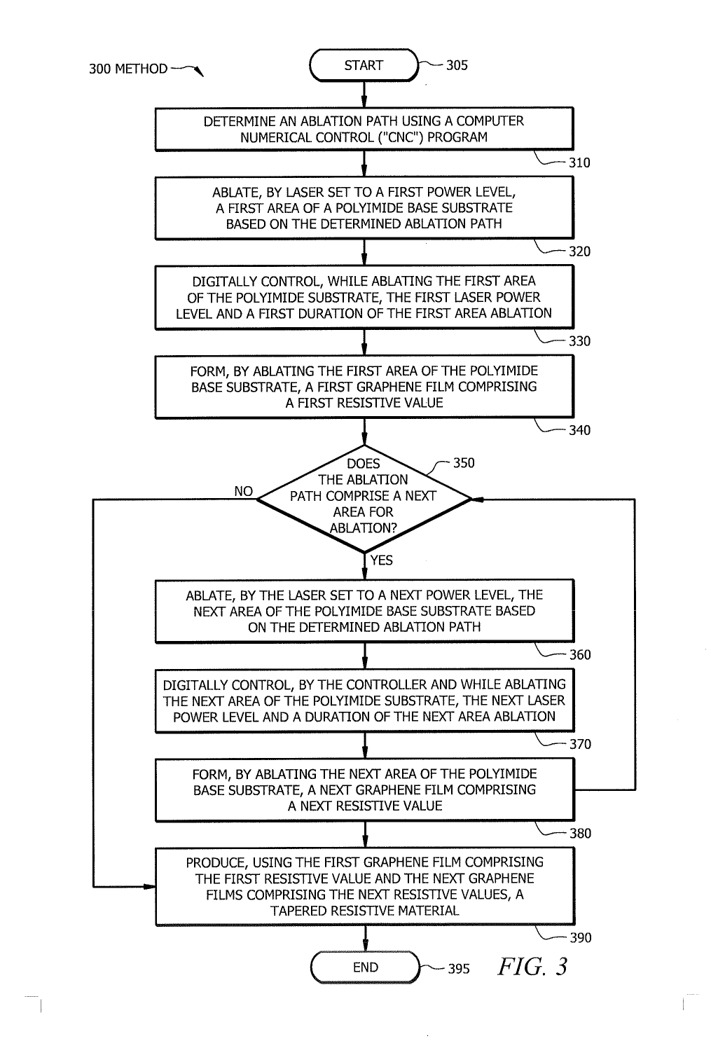

FIG. 3 illustrates a method for producing a tapered resistive material, according to certain embodiments. Method 300 starts at step 305. At step 310, an ablation path is determined using a CNC program. Method 300 then moves to step 320, where a laser set to a first power level ablates a first area of a polyimide base substrate based on the determined ablation path. For example, laser 120 may ablate an area of substrate 130 based on ablation path 200. At step 330 of method 300, a controller digitally controls, while ablating the first area of the polyimide substrate, the first laser power level and a first duration of the first area ablation. In certain embodiments, controller 140 sets the first laser power level to a level operable to achieve a predetermined first resistive value.

Method 300 then moves to step 340, where a first carbonaceous material film comprising a first resistive value is formed by ablating the first area of the polyimide base substrate. As an example, a carbonaceous material film with a resistive value of 600 ohms-per-square may be formed by ablating substrate 130 with laser 120. At step 350, a controller determines whether the ablation path comprises a second area for ablation. If the controller determines the ablation path does not comprise a second area for laser ablation, method 300 proceeds to step 390, which is described below. If the controller determines the that the ablation path comprises a second area for ablation, method 300 proceeds to step 360.

At step 360, the laser ablates the second area of the polyimide base substrate based on the determined ablation path while the laser is set to a second power level. At step 370 of method 300, the controller digitally controls the second laser power level and a second duration of the second area of ablation while the laser ablates the second area of the polyimide substrate. For example, controller 140 may change the first laser power level to the second laser power level by adjusting the power wattage of the laser. In some embodiments, the second power level may be higher or lower than the first power level, depending on the desired resistive value of the second area. In some embodiments, controller 140 may adjust the first duration to a second duration, wherein the laser ablates the second area for a different duration of time than the first area. In certain embodiments, the laser power level and/or the duration of laser ablation may remain constant for consecutive areas.

Method 300 then proceeds to step 380, where a second carbonaceous material film comprising a second resistive value is formed by ablating the second area of the polyimide base substrate. After step 380, method 300 of FIG. 3 proceeds back to step 350 to determine whether the ablation path comprises a third area for ablation. If the controller determines that the ablation path comprises a third area for ablation, method 300 proceeds through steps 360 to 380 in a similar fashion to the steps described above for the second area for ablation. This cycle continues until the ablation path is complete, at which point method 300 proceeds to step 390.

At step 390, a tapered resistive material is produced using the first carbonaceous material film comprising the first resistive value, the second carbonaceous material film comprising the second resistive value, and so on. The tapered resistive material may be a capacitive sheet or a tapered resistive card. The produced tapered resistive material may comprise multiple different resistive values based on the laser ablation process.

FIG. 4 illustrates a computer system that may be used by the system of FIG. 1, according to certain embodiments. One or more computer systems 400 perform one or more steps of one or more methods described or illustrated herein. In particular embodiments, one or more computer systems 400 provide functionality described or illustrated herein. In particular embodiments, software running on one or more computer systems 400 performs one or more steps of one or more methods described or illustrated herein or provides functionality described or illustrated herein. Particular embodiments include one or more portions of one or more computer systems 400. Herein, reference to a computer system may encompass a computing device, and vice versa, where appropriate. Moreover, reference to a computer system may encompass one or more computer systems, where appropriate.

This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 400 may include one or more computer systems 400; be unitary or distributed; span multiple locations; span multiple machines; span multiple data centers; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

In particular embodiments, computer system 400 includes a processor 402 (e.g., controller 140) memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In particular embodiments, processor 402 includes hardware for executing instructions, such as those making up a computer program. As an example and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In particular embodiments, processor 402 may include one or more internal caches for data, instructions, or addresses. This disclosure contemplates processor 402 including any suitable number of any suitable internal caches, where appropriate. As an example and not by way of limitation, processor 402 may include one or more instruction caches, one or more data caches, and one or more translation lookaside buffers (TLBs). Instructions in the instruction caches may be copies of instructions in memory 404 or storage 406, and the instruction caches may speed up retrieval of those instructions by processor 402. Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In particular embodiments, processor 402 may include one or more internal registers for data, instructions, or addresses. This disclosure contemplates processor 402 including any suitable number of any suitable internal registers, where appropriate. Where appropriate, processor 402 may include one or more arithmetic logic units (ALUs); be a multi-core processor; or include one or more processors 402. Although this disclosure describes and illustrates a particular processor, this disclosure contemplates any suitable processor.

In particular embodiments, memory 404 includes main memory for storing instructions for processor 402 to execute or data for processor 402 to operate on. As an example and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In particular embodiments, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere). One or more memory buses (which may each include an address bus and a data bus) may couple processor 402 to memory 404. Bus 412 may include one or more memory buses, as described below. In particular embodiments, one or more memory management units (MMUs) reside between processor 402 and memory 404 and facilitate accesses to memory 404 requested by processor 402. In particular embodiments, memory 404 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 404 may include one or more memories 404, where appropriate. Although this disclosure describes and illustrates particular memory, this disclosure contemplates any suitable memory.

In particular embodiments, storage 406 includes mass storage for data or instructions. As an example and not by way of limitation, storage 406 may include a hard disk drive (HDD), a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to computer system 400, where appropriate. In particular embodiments, storage 406 is non-volatile, solid-state memory. In particular embodiments, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In particular embodiments, I/O interface 408 (e.g., interface 256 or interface 356) includes hardware, software, or both, providing one or more interfaces for communication between computer system 400 and one or more I/O devices. Computer system 400 may include one or more of these I/O devices, where appropriate. One or more of these I/O devices may enable communication between a person and computer system 400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In particular embodiments, communication interface 410 (e.g., interface 256 or interface 356) includes hardware, software, or both providing one or more interfaces for communication (such as, for example, packet-based communication) between computer system 400 and one or more other computer systems 400 or one or more networks. As an example and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it. As an example and not by way of limitation, computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In particular embodiments, bus 412 includes hardware, software, or both coupling components of computer system 400 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

The components of computer system 400 may be integrated or separated. In some embodiments, components of computer system 400 may each be housed within a single chassis. The operations of computer system 400 may be performed by more, fewer, or other components. Additionally, operations of computer system 400 may be performed using any suitable logic that may comprise software, hardware, other logic, or any suitable combination of the preceding.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method, comprising:
determining an ablation path using a computer numerical control (“CNC”) program;
ablating, by a laser set to a first power level, a first area of a polyimide base substrate based on the determined ablation path;
digitally controlling, by a controller and while ablating the first area of the polyimide substrate, the first laser power level and a first duration of the first area ablation;
forming, by ablating the first area of the polyimide base substrate, a first carbonaceous material film comprising a first resistive value;
ablating, by the laser set to a second power level, a second area of the polyimide base substrate based on the determined ablation path;
digitally controlling, by the controller and while ablating the second area of the polyimide substrate, the second laser power level and a second duration of the second area ablation;
forming, by ablating the second area of the polyimide base substrate, a second carbonaceous material film comprising a second resistive value; and
producing, using the first carbonaceous material film comprising the first resistive value and the second carbonaceous material film comprising the second resistive value, a tapered resistive material.

2. The method of claim 1, wherein:
the laser comprises a first laser and a second laser;
the first laser ablates the first area of the polyimide base substrate; and
the second laser ablates the second area of the polyimide base substrate.

3. The method of claim 1, wherein the laser operates with a wavelength in a near to mid infrared regime.

4. The method of claim 1, wherein the laser is a carbon dioxide laser.

5. The method of claim 1, wherein the first area and the second area of the polyimide base substrate are on a two-dimensional surface of the polyimide base substrate.

6. The method of claim 1, wherein the first area and the second area of the polyimide base substrate are on a three-dimensional surface of the polyimide base substrate.

7. A method, comprising:
ablating, by a laser set to a first power level, a first area of a polyimide base substrate;
forming, by ablating the first area of the polyimide base substrate, a first carbonaceous material film comprising a first specific resistive value;
ablating, by the laser set to a second power level, a second area of the polyimide base substrate;
forming, by ablating the second area of the polyimide base substrate, a second carbonaceous material film comprising a second specific resistive value; and
producing, by forming the first carbonaceous material film comprising the first specific resistive value and the second carbonaceous material film comprising the second specific resistive value, a tapered resistive material.

8. The method of claim 7, further comprising:
determining an ablation path using a computer numerical control (“CNC”) program; and
ablating the first and second areas of the polyimide base substrate based on the determined ablation path.

9. The method of claim 7, further comprising:
digitally controlling, while ablating the first area of the polyimide substrate, the first laser power level and a first duration of the first area ablation; and
digitally controlling, while ablating the second area of the polyimide substrate, the second laser power level and a second duration of the second area ablation.

10. The method of claim 7, wherein:
the laser comprises a first laser and a second laser;
the first laser ablates the first area of the polyimide base substrate; and
the second laser ablates the second area of the polyimide base substrate.

11. The method of claim 7, wherein the laser operates with a wavelength in a near to mid infrared regime.

12. The method of claim 7, wherein the laser is a carbon dioxide laser.

13. The method of claim 7, wherein the first area and the second area of the polyimide base substrate are on a two-dimensional surface of the polyimide base substrate.

14. The method of claim 7, wherein the first area and the second area of the polyimide base substrate are on a three-dimensional surface of the polyimide base substrate.

15. A tapered resistive material, comprising:
a first carbonaceous material film comprising a first resistive value, the first resistive value formed by ablating a first area of a polyimide base substrate with a laser while the laser is set to a first power level; and
a second carbonaceous material film comprising a second resistive value formed by ablating a second area of the polyimide base substrate with the laser while the laser is set to a second power level.

16. The tapered resistive material of claim 15, wherein:
the laser comprises a first laser and a second laser;
the first area of the polyimide base substrate is ablated with the first laser; and
the second area of the polyimide base substrate is ablated with the second laser.

17. The tapered resistive material of claim 15, wherein the laser operates with a wavelength in a near to mid infrared regime.

18. The tapered resistive material of claim 15, wherein the laser is a carbon dioxide laser.

19. The tapered resistive material of claim 15, wherein the first area and the second area of the polyimide base substrate are on a two-dimensional surface of the polyimide base substrate.

20. The method of claim 7, wherein the first area and the second area of the polyimide base substrate are on a three-dimensional surface of the polyimide base substrate.
